(19) United States
(12) Patent Application Publication
(10) Pub. No.: US 2002/0197138 A1
(43) Pub. Date: Dec. 26, 2002

(54) Exchanger for tray feeder

(75) Inventors: Jae Hyuk Cho, Kyungki-do (KR); Sang Won Lee, Kyungki-do (KR); Dong Suh Lee, Seoul (KR)

Correspondence Address: FLESHNER & KIM, LLP, P.O. Box 221200, Chantilly, VA, 20153-1200, US

(73) Assignee: MIRAE CORPORATION

(21) Appl. No.: 10/061,410

(22) Filed: Feb. 4, 2002

(30) Foreign Application Priority Data
Jun. 22, 2001 (KR) 2001-35776

(51) Int. Cl. B65G 65/00

(52) U.S. Cl. 414/416.03

(57) ABSTRACT

The present invention discloses an exchanger for a tray feeder for transferring and exchanging a tray plate comprising: first and second support frames; a guide support unit including a support frame installed between the first and second support frames; a vacuum generator provided with a side of the first support frame; a nozzle support unit including a pitting unit for transferring a vacuum suction force by connecting it to the vacuum generator, a plurality of vacuum pad for performing a grasp of the tray plate with the vacuum suction force transferred from the pitting unit, and a plurality of stopper capable of supporting the tray plate; a head block connected to a side of the nozzle support unit; a guide block installed to a second belt as a state connected to the head block, thereby capable of guiding the nozzle support unit; a transfer means for transferring the guide block; a driving means for driving the transfer means.

### BACKGROUND OF THE INVENTION

1. Field of the Invention

The present invention relates to an exchanger for a tray feeder, and in particular to an improved exchanger for a tray feeder which can put or fetch a tray on which an electronic parts is mounted in/from a magazine.

2. Description of the Background Art

Referring to FIGS. 1 and 2, in a conventional electronic parts feeder for feeding an electronic parts along a tray, a magazine 3 receiving the electronic parts 4 is supported by a lifter 7 lifted or lowered along a ball screw 6 driven by a driving motor 5.

When a necessary electronic parts 4 is selected, the lifter 7 is moved in an upper or lower direction. The magazine 3 receiving a tray plate 2 is supported on the lifter 7. After a position of the lifter 7 is decided, the tray plate 2 received in the magazine 3 is grasped and transferred by driving of a tray plate fetch unit 8.

Thereafter, the electronic parts 4 is moved to the upper portion of a centering table 11 by a moving unit 10 having a moving nozzle 9. The centering table 11 on which the electronic parts is put is moved to the mounter side, thereby supplying the electronic parts 4.

However, the conventional electronic parts feeder has a disadvantage in that, when the tray plate fetch unit 8 is driven to grasp and fetch the tray plate 2 received in the magazine 3 during the operation of the mounter, the tray plate 2 received in the magazine 3 does not maintain a constant position by shaking due to the driving of the electronic parts feeder. As a result, the tray plate fetch unit 8 incompletely or imprecisely grasps the tray plate 2, and thus the electronic parts are not normally mounted.

### SUMMARY OF THE INVENTION

Accordingly, it is an object of the present invention to provide an exchanger for a tray feeder which can easily grasp a tray plate receiving an electronic parts with a suction force of a plurality of vacuum pads of a nozzle support unit, and which can stably precisely replace the tray plate.

In order to achieve the above-described object of the invention, there is provided an exchanger for a tray feeder for transferring and exchanging a tray plate comprising: first and second support frames; a guide support unit including a support frame installed between the first and second support frames; a vacuum generator provided with a side of the second support frame; a nozzle support unit including a pitting unit for transferring a vacuum suction force by connecting it to the vacuum generator, a plurality of vacuum pad for performing a grasp of the tray plate with the vacuum suction force transferred from the pitting unit, and a plurality of stopper capable of supporting the tray plate; a head block connected to a side of the nozzle support unit; a guide block installed to a second belt as a state connected to the head block, thereby capable of guiding the nozzle support unit; a transfer means for transferring the guide block; a driving means for driving the transfer means.

### BRIEF DESCRIPTION OF THE DRAWINGS

The present invention will become better understood with reference to the accompanying drawings which are given only by way of illustration and thus are not limitative of the present invention, wherein:

FIG. 1 is a perspective view illustrating a means for putting a tray in a magazine in a conventional electronic parts feeder;

FIG. 2 is a perspective view illustrating the conventional electronic parts feeder;

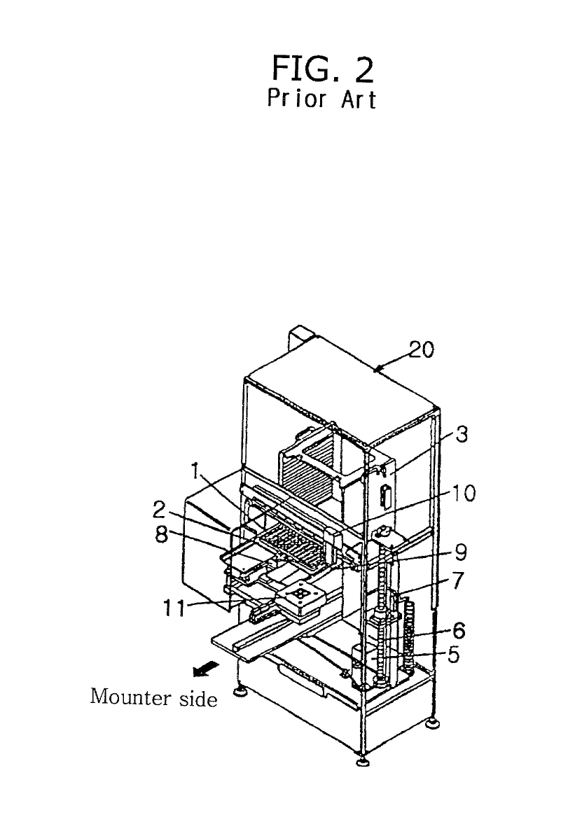

FIG. 3 is a perspective view illustrating a tray feeder having an exchanger in accordance with the present invention;

FIG. 4 is a rear-perspective view illustrating a main frame of the tray feeder;

FIG. 5 is a perspective view illustrating the exchanger; and

FIG. 6 is a perspective view illustrating a nozzle support unit of the exchanger.

### DETAILED DESCRIPTION OF THE PREFERRED EMBODIMENTS

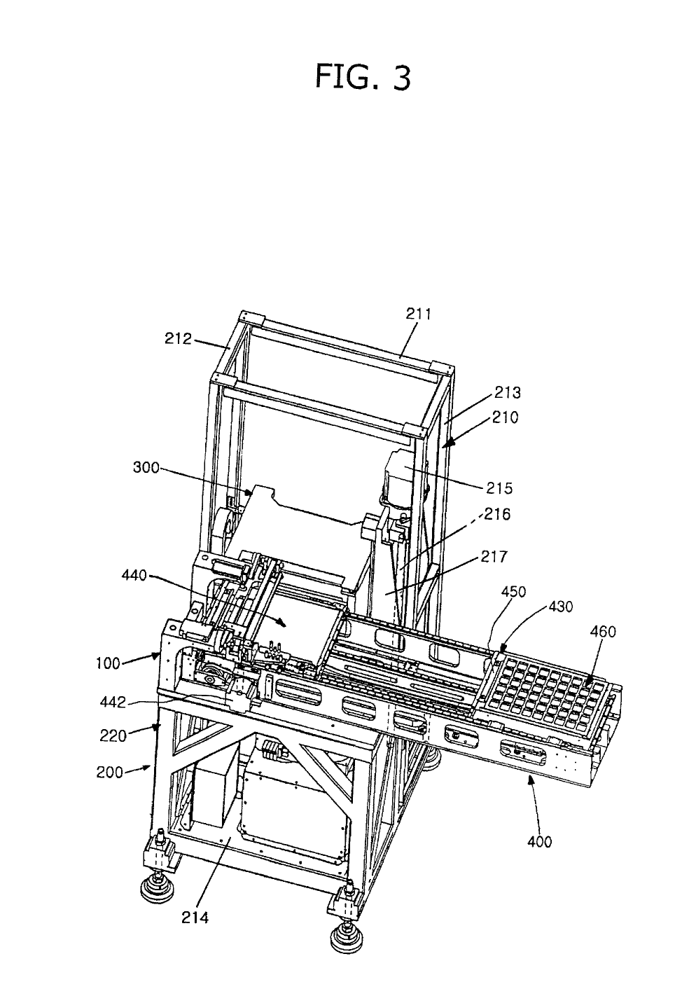

An exchanger for a tray feeder in accordance with a preferred embodiment of the present invention will now be described in detail with reference to FIGS. 3 to 5.

The tray feeder (referred to as ‘electronic parts feeder’) of the present invention includes: an exchanger 100 for putting or fetching a plurality of tray plates 450; a stacker 200; a magazine 300 and a transfer 400.

The stacker 200 includes a cover frame 210 and a main frame 220.

The cover frame 210 has a plurality of horizontal frames 211, longitudinal frames 212 and vertical frames 213 to surround an outer portion thereof. A base unit 214 is formed at the lower portion of the vertical frames 213.

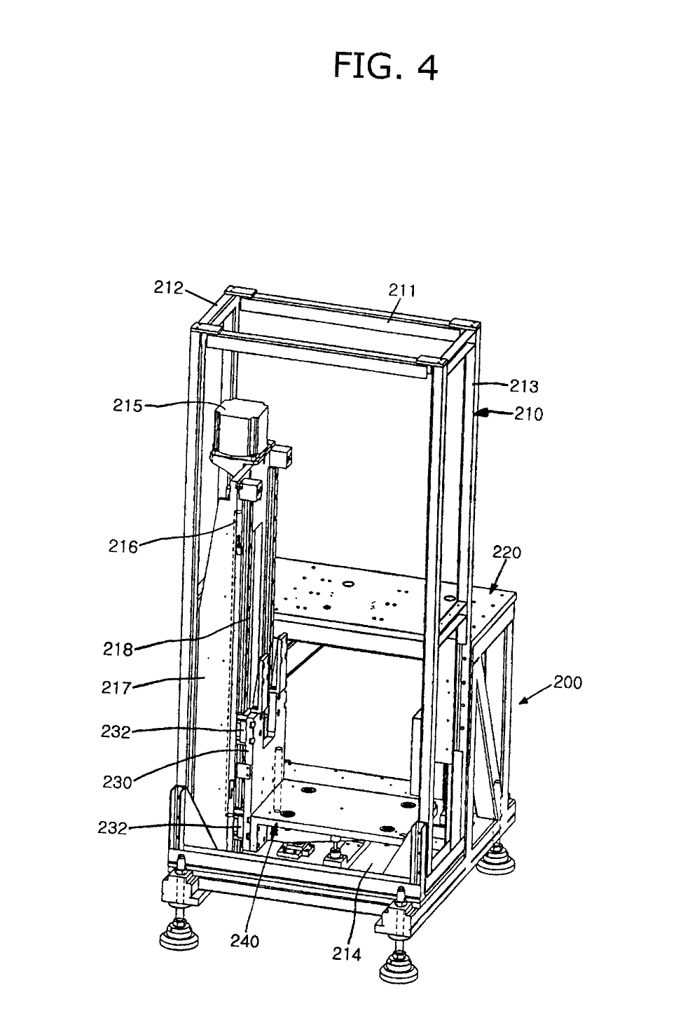

As illustrated in FIGS. 3 and 4, the transfer 400 and the exchange 100 are connected at the upper portion of the main frame 220 positioned at one side portion of the cover frame 210.

A motor 215 is installed at one side portion of the upper portion of a support frame 217 positioned at one side portion of the main frame 220. A ball screw 216 is connected to a motor shaft (not shown) of the driving motor 215. Since the ball screw 216 is connected to one side portion of an elevator 240, when the ball screw 216 is operated by driving the driving motor 215, the elevator 240 is moved in a predetermined direction.

In addition, a plurality of LM guides 218 for guiding the elevator 240 positioned on the base unit 214 are installed at one side portion of the support frame 217.

A plurality of guide blocks 232 connected to one side portion of the elevator 240 are inserted into the plurality of LM guides 218. The other portions of the guide blocks 232 are connected to one side portion of the guide frame 230 connected to the elevator 240, thereby lifting or lowering the elevator 240.

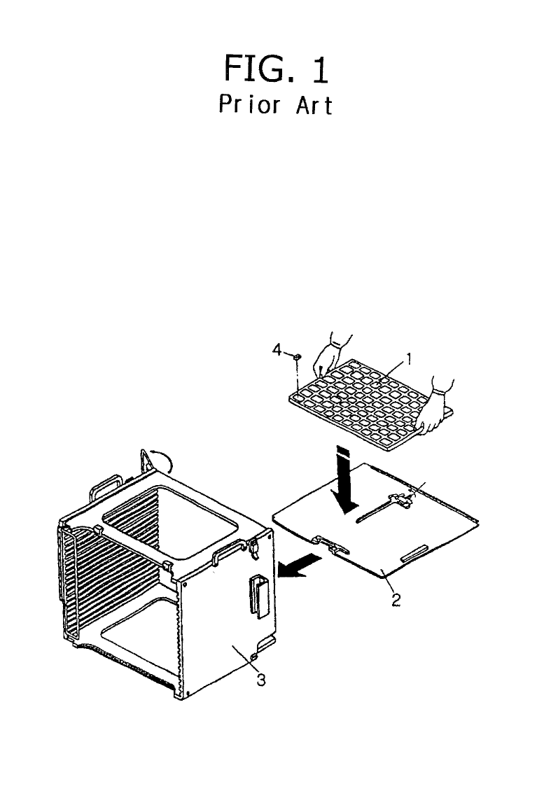

A plurality of electronic parts (refer to FIG. 1) are mounted on the plurality of trays 460 in the magazine 300. The plurality of trays 460 are mounted on the plurality of tray plates 450.

First and second plates 430 and 440 for transferring the tray plates 450 are positioned at both end portions of the upper portion of the transfer 400 at a predetermined interval, and a driving unit 442 is formed at one side portion thereof, thereby driving the first and second plates 430 and 440.

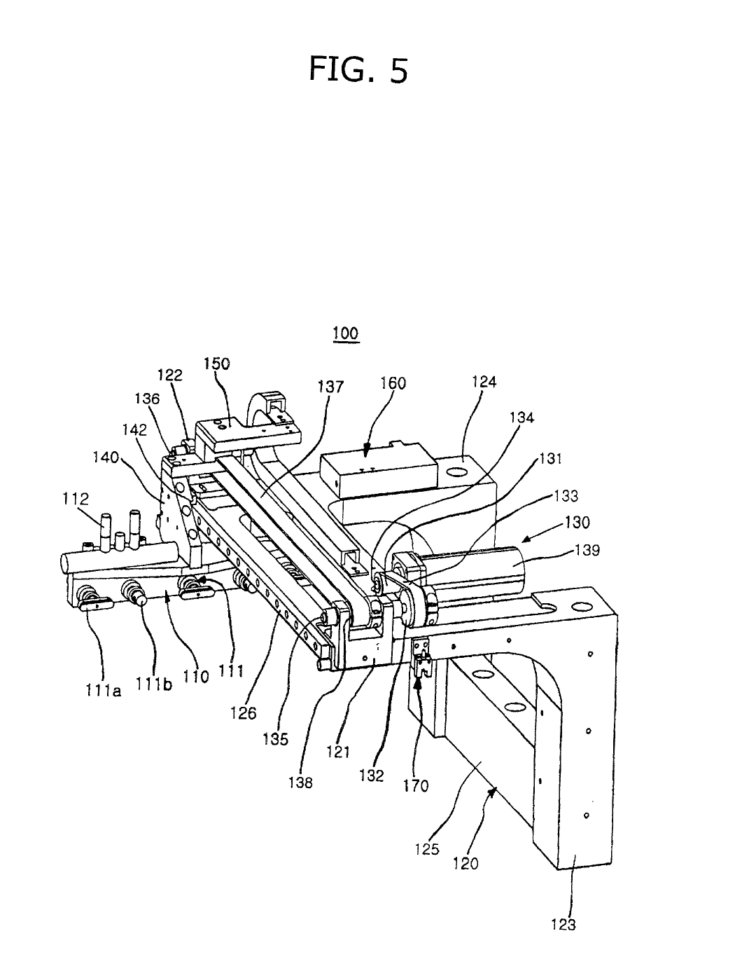

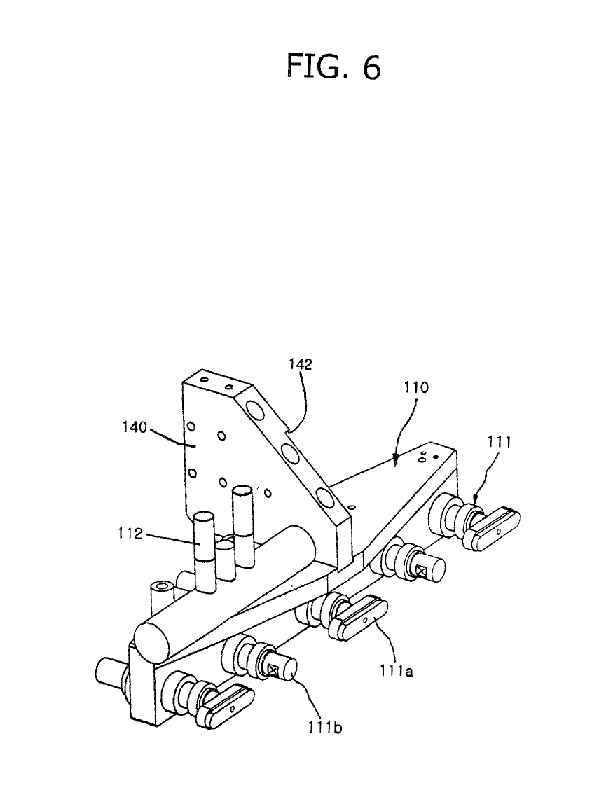

FIG. 5 is a perspective view illustrating the exchanger of FIG. 3, and FIG. 6 is an enlarged perspective view illustrating the nozzle support unit of the exchanger.

The exchanger 100 includes: a nozzle support unit 110; a guide support unit 120; a driving unit 130; a guide block 150; and a head block 140.

The guide support unit 120 includes a first support frame 123 and a second support frame 124 positioned at both ends of the support frame 125. First and second support blocks 121 and 122 are installed at one end portions of the first and second support frames 123 and 124. LM guides 126 are installed at both end portions of the first and second support blocks 121 and 122.

A sensor unit 170 for sensing a position and distance of the tray plate 450 is formed at one side portion of the first support frame 123. The driving unit 130 for moving the nozzle support unit 110 is formed at the other side portion thereof.

A driving shaft 134 is connected to a motor 139 of the driving unit 130. In the driving shaft 134, a first belt 133 is wounded and positioned in a driving pulley 131 and an idle pulley 132. The idle pulley 132 is inserted and connected to a first roller shaft 135.

A first roller 138 is connected to one end portion of the first roller shaft 135, and a second roller (not shown) is connected to one end portion of a second roller shaft 136. A second belt 137 is wounded in the first and second rollers. The first roller shaft 135 is rotated, inserted into the guide block 121. The second roller is inserted into the second roller shaft 136, and the second roller shaft 136 is rotated, supported by the second support block 122. The second support block 122 is formed at one end portion of the second support frame 124.

A vacuum generator 160 is installed on the second support frame 124, and connected to a pitting unit 112 formed at one side portion of the nozzle support unit 110. The guide block 150 is installed on the second belt 137, for performing a guiding operation with the head block 140 formed at the lower portion of the guide block 150. A guide groove 142 is formed at one side portion of the head block 140, so that the LM guide 126 can be inserted thereinto.

The nozzle support unit 110 is formed at the lower end portion of the head block 140. A plurality of nozzles 111 are supported in the nozzle support unit 110. A plurality of vacuum pads 111a for sucking one side portion of the tray plate 450 and a plurality of stopper 111b for supporting one side portion of the tray plate 450 are alternately formed on the respective nozzles 111. The pitting unit 112 for transmitting a suction force from the vacuum generator 160 to the vacuum pads 111a is formed on the nozzle support unit 110. The vacuum generator 160 and the pitting unit 112 are connected through a hose (not shown) for transmitting the suction force.

The operation of the exchanger for the tray feeder in accordance with the present invention will now be explained.

When the tray plate 450 transferred from the electronic parts feeder is received in the magazine 300, and the driving motor 215 installed at one side portion of the cover frame 210 of the tray feeder stacker 200 is driven, the elevator 240 is lifted along the LM guide 218 by rotation of the ball screw 216 connected to a driving shaft (not shown) of the motor 215.

When the elevator 240 is lifted and stops at a predetermined position, the exchanger 100 is operated to fetch the tray plate 450 received in the magazine 300 mounted on the elevator 240.

When the motor 139 of the driving unit 130 provided at one side portion of the guide support unit 120 of the exchanger 100 is driven and the driving shaft 134 connected to the motor 139 is rotated, the driving pulley 131 connected to the driving shaft 134 is rotated. The first belt 133 positioned in the driving pulley 131 is rotated, and the idle pulley 132 is rotated. The idle pulley 132 rotates the first roller shaft 135, inserted into the first roller shaft 135, and the first roller shaft 135 is inserted into the support block 121 and rotated.

When the first roller 138 is rotated by the first roller shaft 135, the second belt 137 positioned in the first and second rollers is rotated along the outer surfaces of the first and second rollers.

Here, the guide block 150 fixed on the second belt 137 is moved in a forward direction along the second belt 137, and the head block 140 and the nozzle support unit 110 connected to the guide block 150 are also moved in a forward direction. The vacuum generator 160 provided at one side portion of the second support frame 124 connected to the pitting unit 112 formed on the nozzle support unit 110 supplies the suction force to the vacuum pads 111a. Thus, when the vacuum pads are installed at the lower portion of the guide block 150, the plurality of vacuum pads 111a formed at one side portion of the nozzle support unit 110 sucks and grasps support protrusions formed at one side portion of the tray plate 450.

When the driving pulley 131 is inversely rotated by inverse-driving of the motor 139 of the driving unit 130 installed at one side portion of the exchanger 110, the driving pulley 131 is inversely rotated, and the first belt 133 is rotated along the outer surfaces of the driving pulley 131 and the idle pulley 132, thereby inversely rotating the idle pulley 132.

When the first roller shaft 135 is inversely rotated, the first roller 138 inserted into the other end portion of the first roller shaft 135 is also inversely rotated, and thus the second belt 137 positioned in the first and second rollers are inversely rotated along the outer surfaces of the first and second rollers.

When the guide block 150 installed on the second belt 137 is moved from the magazine 300 to the rear portion, the nozzle support unit 110 of the head block 140 connected to the guide block 150 grasps the tray plate 450 from the magazine 300, moves in a back ward direction, and fetches it.

When the suction force of the vacuum pads 111a is removed by the operation of the vacuum generator 160, the fetched tray plate 450 is positioned on the second plate 440 formed at the upper portion of the side of the transfer 400. The tray plate 450 is transferred to a mounter by the second plate 440 by driving of the transfer 400. At the same time, the first plate 430 positioned at the other side portion of the transfer 400 is returned to the exchanger side.

The tray plate 450 finishing the mounting operation of the electronic parts is mounted on the first plate 430. A distance and position of the tray plate 450 are sensed by the sensor unit 170 provided at one side portion of the guide support unit 120. When the tray plate 450 stops at a predetermined position, the nozzle support unit 110 formed at one side portion of the exchanger 100 is operated to grasp the tray plate 450.

The tray plate 450 is received in the magazine 300, and then lowered with the magazine 300 by driving of the elevator 240. The electronic parts is mounted on the tray plate 450 received in the magazine 300. Then, the tray plate 450 is received in the magazine 300, and lifted with the magazine 300 to transfer the electronic parts to the mounter.

In accordance with the present invention, when the tray plate 450 on which the electronic parts transferred to the upper portion of the second plate 440 of the transfer 400 is mounted is transferred, the sensor unit 170 provided at one side portion of the guide support unit 120 senses the position of the tray plate 450. Moreover, the tray plate 450 on which the tray 460 receiving the electronic parts is mounted can be stably precisely put and fetched due to suction and grasp of the vacuum pads 111a and fixing and supporting of the stoppers 111b.

As discussed earlier, in accordance with the present invention, the tray plate on which the electronic parts is mounted is precisely grasped by the operation of the tray feeder exchanger, and stably transferred to a predetermined position, which results in improved workability, reliability and productivity.

As the present invention may be embodied in several forms without departing from the spirit or essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

What is claimed is:

1. An exchanger for a tray feeder for transferring and exchanging a tray plate comprising:
first and second support frames;
a guide support unit including a support frame installed between the first and second support frames;
a vacuum generator provided with a side of the second support frame;
a nozzle support unit including a pitting unit for transferring a vacuum suction force by connecting it to the vacuum generator, a plurality of vacuum pad for performing a grasp of the tray plate with the vacuum suction force transferred from the pitting unit, and a plurality of stopper capable of supporting the tray plate;
a head block connected to a side of the nozzle support unit;
a guide block installed to a second belt as a state connected to the head block, thereby capable of guiding the nozzle support unit;
a transfer means for transferring the guide block;
a driving means for driving the transfer means.

2. The exchanger of claim 1, wherein the transfer means comprises a linear motion guide for guiding the guide block, first and second rollers connected to first and second roller shafts and rotated by a belt wound, first and second support blocks for supporting the first and second shafts, a plurality of pulleys connected to the first roller shaft for transmitting the rotation force, and a motor for driving the plurality of rollers.

3. The exchanger of claim 1, wherein a sensor capable of sensing the position of the tray plate is installed to a side of the first support frame.

4. The exchanger of claim 1, wherein the nozzle support unit is formed at the lower end portion of the head block and a plurality of nozzles are supported in the nozzle support unit and a plurality of vacuum pads for sucking one side portion of the tray plate and a plurality of stopper for supporting one side portion of the tray plate are alternately formed on the respective nozzles.
